(19) United States
(12) Patent Application Publication
(10) Pub. No.: US 2026/0252992 A1
(43) Pub. Date: Aug. 27, 2026

(54) ADAPTIVE WORKFLOW MANAGEMENT FOR DYNAMIC TASK ORCHESTRATION USING MULTI-AGENT COLLABORATION

(71) Applicant: Raytheon Company, Arlington, VA (US)

(72) Inventors: Darrell L. Young, Quinlan, TX (US); Christine Rachael Nezda, Richardson, TX (US); Joshua A. Binkley, Plano, TX (US); Michael K. Nolan, Framingham, MA (US); Hanna Alyse Hart, Murphy, TX (US); Hninn Ou Khin, Tysons, VA (US)

(21) Appl. No.: 19/065,589

(22) Filed: Feb. 27, 2025

(51) Int. Cl. G06Q 10/0631

(52) U.S. Cl. CPC G06Q 10/06316

(57) ABSTRACT

At least one data storage is configured to store historical user inputs and historical generated workflows. One or more processing devices are configured to execute a context estimation agent (CEA), a workflow composer agent (WCA), a workflow supervisor agent (WSA), a worker agent, and a recommendation agent (RA). The CEA is configured to analyze the historical user inputs and the historical generated workflows to estimate a context of a current user input. The WCA is configured to generate one or more adaptive workflows based on the context estimated by the CEA. The WSA is configured to map one or more computing tasks to the worker agent. The worker agent is configured to provide one or more status updates of task execution to the CEA. The RA is configured to recommend one or more next steps to one or more users.

### TECHNICAL FIELD

This disclosure relates generally to machine learning systems and processes. More specifically, this disclosure relates to adaptive workflow management for dynamic task orchestration using multi-agent collaboration.

### BACKGROUND

Workflow management systems are platforms that integrate several disparate workflow tools to help analyze, control, and monitor processes and workflows. Among other things, these systems can often document steps needed to complete tasks and can automate repetitive tasks. However, workflow management system may rely on static workflows that do not adapt based on real-time feedback or historical data. This limits the effectiveness of these workflow management systems in rapidly-changing environments where context and user needs can shift unexpectedly.

### SUMMARY

This disclosure relates to adaptive workflow management for dynamic task orchestration using multi-agent collaboration.

In some examples, a system includes at least one data storage configured to store historical user inputs and historical generated workflows. The system also includes one or more processing devices configured to execute a context estimation agent (CEA), a workflow composer agent (WCA), a workflow supervisor agent (WSA), a worker agent, and a recommendation agent (RA). The CEA is configured to analyze the historical user inputs and the historical generated workflows using retrieval-augmented generation to estimate a context of a current user input. The WCA is configured to generate one or more adaptive workflows in response to the current user input based on the context estimated by the CEA such that the one or more adaptive workflows are adjusted using feedback from one or more execution results and are visualized using a visualization agent (VA). The WSA is configured to map one or more computing tasks to the worker agent. The worker agent is configured to provide one or more status updates of task execution to the CEA. The RA is configured to recommend one or more next steps to one or more users based on one or more results from the one or more adaptive workflows.

Any single one or any combination of the following features may be used with the examples above. The at least one data storage component may be configured to categorize the historical user inputs and the historical generated workflows based on domain classification for efficient retrieval by the CEA. The CEA may be configured to identify one or more patterns in the historical user inputs and the historical generated workflows to estimate the context of the current user input. The CEA may be configured to use the RA and the VA to update the one or more adaptive workflows dynamically based on user feedback and one or more execution outcomes. The worker agent may be configured to provide one or more real-time status updates of workflow execution to the CEA such that the one or more real-time status updates can be compared to one or more expected outputs generated by the WCA to determine if the one or more adaptive workflows are proceeding without error. The worker agent may be configured to communicate a presence of any error to the CEA and the RA. The CEA may be configured to receive one or more instructions from one or more users to modify the one or more adaptive workflows in real-time and provide one or more instructions for a workflow modification to the WCA for continuous adaptation.

In other examples, a non-transitory machine-readable medium includes program code that, when executed by at least one processor of an electronic device, causes the electronic device to store historical user inputs and historical generated workflows. The non-transitory machine-readable medium also includes program code that, when executed by the at least one processor, causes the electronic device to execute a CEA, a WCA, a WSA, a worker agent, and an RA. The CEA is configured to analyze the historical user inputs and the historical generated workflows using retrieval-augmented generation to estimate a context of a current user input. The WCA is configured to generate one or more adaptive workflows in response to the current user input based on the context estimated by the CEA such that the one or more adaptive workflows are adjusted using feedback from one or more execution results and are visualized using a VA. The WSA is configured to map one or more computing tasks to the worker agent. The worker agent is configured to provide one or more status updates of task execution to the CEA. The RA is configured to recommend one or more next steps to one or more users based on one or more results from the one or more adaptive workflows.

Any single one or any combination of the following features may be used with the examples above. The non-transitory machine-readable medium may include program code that, when executed by the at least one processor, causes the electronic device to categorize the historical user inputs and the historical generated workflows based on domain classification for efficient retrieval by the CEA. The non-transitory machine-readable medium may include program code that, when executed by the at least one processor, causes the electronic device to identify one or more patterns in the historical user inputs and the historical generated workflows to estimate the context of the current user input. The CEA may be configured to use the RA and the VA to update the one or more adaptive workflows dynamically based on user feedback and one or more execution outcomes. The worker agent may be configured to provide one or more real-time status updates of workflow execution to the CEA such that the one or more real-time status updates can be compared to one or more expected outputs generated by the WCA to determine if the one or more adaptive workflows are proceeding without error. The worker agent may be configured to communicate a presence of any error to the CEA and the RA. The CEA may be configured to receive one or more instructions from one or more users to modify the one or more adaptive workflows in real-time and provide one or more instructions for a workflow modification to the WCA for continuous adaptation.

In still other examples, a method includes storing historical user inputs and historical generated workflows. The method also includes executing a CEA, a WCA, a WSA, a worker agent, and an RA. The CEA analyzes the historical user inputs and the historical generated workflows using retrieval-augmented generation to estimate a context of a current user input. The WCA generates one or more adaptive workflows in response to the current user input based on the context estimated by the CEA such that the one or more adaptive workflows are adjusted using feedback from one or more execution results and are visualized using a VA. The WSA maps one or more computing tasks to the worker agent. The worker agent provides one or more status updates of task execution to the CEA. The RA recommends one or more next steps to one or more users based on one or more results from the one or more adaptive workflows.

Any single one or any combination of the following features may be used with the examples above. The method may include categorizing the historical user inputs and the historical generated workflows based on domain classification for efficient retrieval by the CEA. The CEA may identify one or more patterns in the historical user inputs and the historical generated workflows to estimate the context of the current user input. The CEA may use the RA and the VA to update the one or more adaptive workflows dynamically based on user feedback and one or more execution outcomes. The worker agent may provide one or more real-time status updates of workflow execution to the CEA such that the one or more real-time status updates can be compared to one or more expected outputs generated by the WCA to determine if the one or more adaptive workflows are proceeding without error. The worker agent may communicate a presence of any error to the CEA and the RA. The CEA may receive one or more instructions from one or more users to modify the one or more adaptive workflows in real-time and provide one or more instructions for a workflow modification to the WCA for continuous adaptation.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example system supporting generation of adaptive workflows using historical and current user inputs according to this disclosure;

FIG. 2 illustrates an example device supporting generation of adaptive workflows using historical and current user inputs according to this disclosure;

FIG. 3 illustrates an example architecture supporting generation of adaptive workflows using historical and current user inputs according to this disclosure;

FIG. 4 illustrates an example method for generating adaptive workflows using historical and current user inputs in accordance with this disclosure; and

FIG. 5 illustrates an example method for storing historical user inputs and historical generated workflows in a data storage component to support generation of adaptive workflows using historical and current user inputs according to this disclosure.

### DETAILED DESCRIPTION

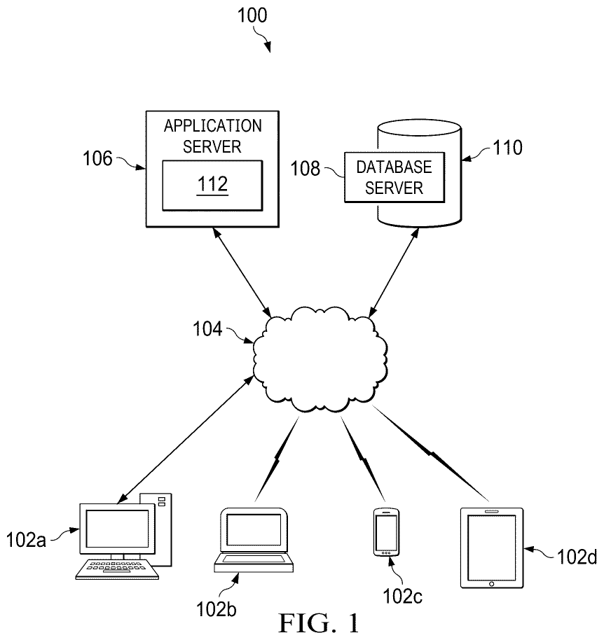

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, workflow management systems are platforms that integrate several disparate workflow tools to help analyze, control, and monitor processes and workflows. Among other things, these systems can often document steps needed to complete tasks and can automate repetitive tasks. However, workflow management system may rely on static workflows that do not adapt based on real-time feedback or historical data. This limits the effectiveness of these workflow management systems in rapidly-changing environments where context and user needs can shift unexpectedly. Existing solutions may involve natural language processing, machine learning models, or rule-based systems, but these solutions lack comprehensive integration of past interactions to inform current decision-making processes.

This disclosure provides various techniques for generating adaptive workflows using prior context. For example, multiple agents may collaborate dynamically to refine and execute workflows in real-time based on user inputs and feedback. The multiple agents can include a context estimation agent, a workflow composer agent, a workflow supervisor agent, a recommendation agent, and a visualization agent. The context estimation agent can estimate the context of a current user input by referencing historical user input and corresponding historical generated workflows to add context to the current user input. This context estimation, as well as the current user input, can be used by the workflow composer agent to generate one or more adaptive workflows responsive to the current user input. The one or more adaptive workflows may be modified by the context estimation agent in conjunction with the workflow composer agent based on feedback from one or more users, one or more results of the workflow being performed, or a combination thereof. In this way, the described techniques may generate and adapt workflows using historical data and real-time execution results.

FIG. 1 illustrates an example system 100 supporting generation of adaptive workflows using historical and current user inputs according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112. At least one application 112 may be configured to retrieve information from the database 110 via the database server 108 for processing and/or provide information to the database 110 via the database server 108 for storage. The application or applications 112 may support any desired functionality in the system 100. For example, one or more applications 112 may perform the functions described below to generate and modify adaptive workflows using historical and current user inputs. Once one or more adaptive workflows are generated, the same application(s) 112 or one or more different applications 112 may use the one or more adaptive workflows during operation, or the one or more adaptive workflows may be deployed to one or more other devices (such as one or more user devices 102a-102d) for use.

The database server 108 operates to store and facilitate retrieval of various information used, generated, or collected by the application server 106 and the user devices 102a-102d in the database 110. For example, the database server 108 may store various information in relational database tables or other data structures in the database 110. Note that the database server 108 may also be used within the application server 106 to store information, in which case the application server 106 may store the information itself.

Although FIG. 1 illustrates one example of a system 100 supporting generation of adaptive workflows using historical and current user inputs, various changes may be made to FIG. 1. For example, the system 100 may include any number of user devices 102a-102d, networks 104, application servers 106, database servers 108, databases 110, and applications 112. Also, these components may be located in any suitable locations and might be distributed over a large area. In addition, while FIG. 1 illustrates one example operational environment in which adaptive workflow generation using historical and current user inputs may be used, part or all of these functionalities may be used in any other suitable system.

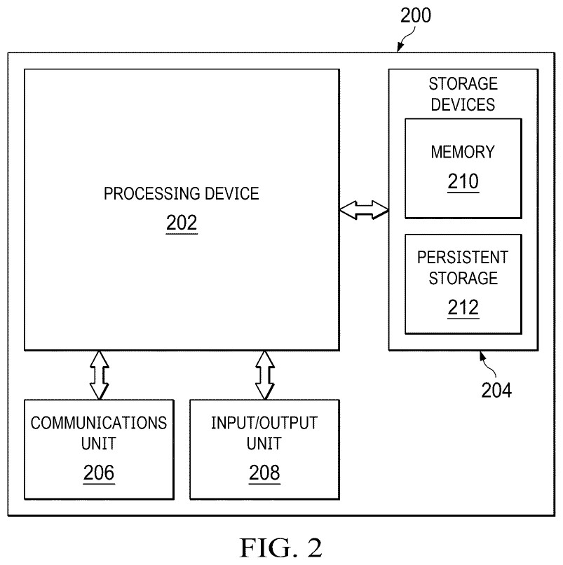

FIG. 2 illustrates an example device 200 supporting generation of adaptive workflows using historical and current user inputs according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), graphics processing units (GPUs), neural processing units (NPUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over at least one wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application server 106. Thus, for example, the instructions executed by the processing device 202 may cause the application server 106 to perform the functions described below in order to generate adaptive workflows using historical and current user inputs and optionally to use the adaptive workflows. The instructions executed by the processing device 202 may also or alternatively cause the application server 106 to perform the functions described below in order to implement one or more adaptive workflows, which may or may not be performed as part of the generation of the adaptive workflow(s).

Although FIG. 2 illustrates one example of a device 200 supporting generation of adaptive workflows using historical and current user inputs, various changes may be made to FIG. 2. For example, computing and communication devices and systems come in a wide variety of configurations, and FIG. 2 does not limit this disclosure to any particular computing or communication device or system.

The following now describes how adaptive workflows may be generated using historical and current user inputs, as well as historical generated workflows, and how real-time modifications to adaptive workflows may be provided. For ease of explanation, it may be assumed in the following discussion that adaptive workflows are generated, modified, and/or executed using one or more processing devices 202 of at least one electronic device, such as the application server 106 and/or the user device(s) 102a-102d. However, the techniques described below may be performed using any suitable device(s) and in any suitable system(s).

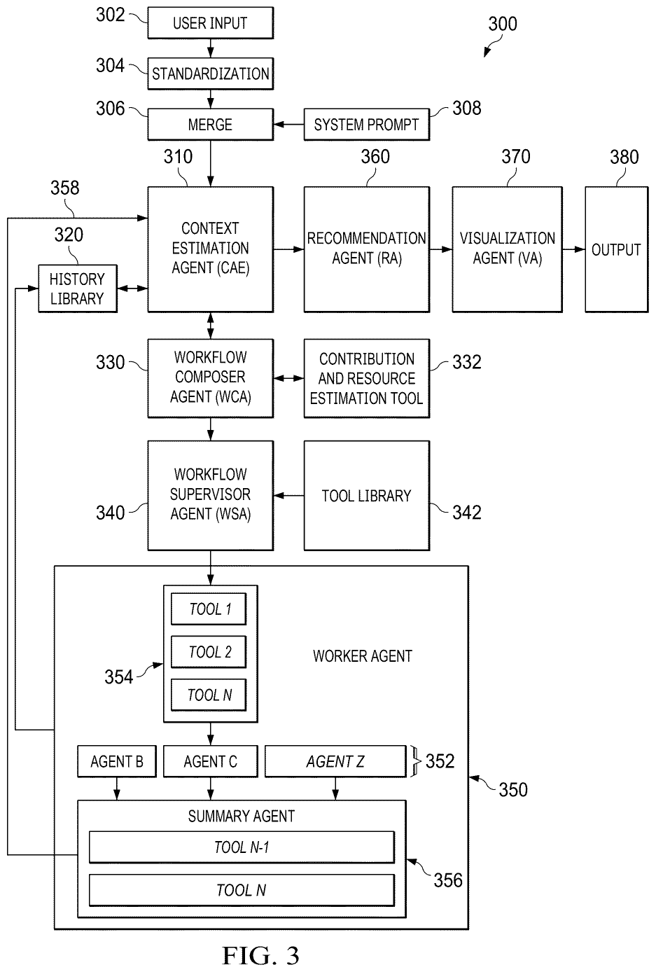

FIG. 3 illustrates an example architecture 300 supporting generation of adaptive workflows using historical and current user inputs according to this disclosure. In some embodiments, the architecture 300 may be implemented using one or more applications 112 that are executed by the application server 106 in the system 100 of FIG. 1.

As shown in FIG. 3, the architecture 300 includes a context estimation agent (CEA) 310, a data storage component 320, a workflow composer agent (WCA) 330, a workflow supervisor agent (WSA) 340, a recommendation agent (RA) 360, and a visualization agent (VA) 370. In some embodiments, the CEA 310, WCA 330, WSA 340, RA 360, and VA 370 form a multi-agent system that can be executed by the one or more processing devices 202 of the application server 106, user device(s) 102a-102d, or other electronic device(s). The data storage component 320 represents any suitable data storage device(s) configured to store and facilitate retrieval of information, such as at least one database or other data store.

The architecture 300 may receive a current user input 302, which in this example can be processed by a standardization function 304 and fed into a merge function 306. The merge function 306 may also receive a system prompt 308 before merging the system prompt 308 and the user input. The merged input is provided to the CEA 310, which is communicatively coupled to the data storage component 320. The data storage component 320 may be configured to store historical user inputs and historical generated workflows. As particular examples, the data storage component 320 may store historical user inputs and corresponding generated workflows for efficient retrieval and analysis.

The CEA 310 relies on previous examples in the data storage component 320 to estimate context and suggest workflows for the current user input 302. For example, the CEA 310 may be configured to analyze the historical user inputs and the historical generated workflows and estimate a context of a current user input. The context of the current user input 302 can include, for example, the current chat history with the user along with augmented data provided. As such, to estimate the context of the current user input, the CEA 310 may augment the user input with historical data, such as prior successful or historical workflows, stored in the data storage component 320. As a particular example, the CEA 310 may analyze stored data, such as historical user inputs and historical workflows stored in the data storage component 320, to estimate the context of current user input 302 using rule-based algorithms, large language model (LLM) fine tuning, retrieval-augmented generation (RAG) techniques, or a combination thereof. For instance, the CEA 310 may use one or more RAG techniques, such as cosine matching historical user inputs and subsequent historical generated workflows with the user input 302, to determine patterns and trends in user behaviors and characteristics of desired workflows. The CEA 310 may also rely on other machine learning techniques, such as clustering, to isolate and propagate portions of the current user input that are relevant to the one or more adaptive workflows. The CEA 310 can provide the estimated context of the current user input 302 to the WCA 330.

The WCA 330 may be configured to generate one or more adaptive workflows in response to the current user input 302 based on the context estimated by the CEA 310. For example, the WCA 330 may use the context and the current user input 302 to cause a first subagent to propose one or more workflows, based on historical workflows included in the context estimation, and cause a second subagent to request a resource estimation for the proposed one or more adaptive workflows from a contribution and resource estimation tool 332. The contribution and estimation tool 332 can provide a time estimation as well as a resource, such as memory capability, processing capability, and tool availability, for the proposed one or more adaptive workflows to reach completion. The first subagent of the WCA 330 may incorporate modifications to the proposed one or more adaptive workflows to improve resource efficiency responsive to the current user input 302. Once generated, the WCA 330 provides the one or more adaptive workflows to the WSA 340. The WCA 330 may also refine or suggest a baseline workflow for modification to be incorporated by the WSA 340. In some cases, the CEA 310 may also provide updated estimated context to the WCA 330, which may cause the WCA 330 to update the one or more adaptive workflows. As a particular example, the one or more adaptive workflows may be adjusted using feedback from one or more execution results and visualized using the VA 370.

The WSA 340 may be configured to map one or more compute tasks onto at least one worker agent 350 using available resources. The at least one worker agent 350 may provide status updates to the CEA 310, ensuring workflow execution aligns with planned outcomes. For example, the WSA 340 may be configured to map one or more computing tasks for at least one adaptive workflow based on the estimated context of the current user input 302 to the at least one worker agent 350 and provide status updates of task execution to the CEA 310. In some cases, the WSA 340 may map computing tasks (such as one or more tools 354 pulled from a tool library 342) to a plurality of subagents 352 of the at least one worker agent 350 to implement an adaptive workflow. The WSA 340 may provide status updates 358 via a summary agent 356 of the at least one worker agent 350 regarding the workflow to the CEA 310, and the CEA 310 may determine a feasibility of the workflow based on the status updates, determine whether the workflow was completed by the at least one worker agent 350, or determine whether the context has changed due to workflow discovery. The CEA 310 may also store the adaptive workflow(s) and the current user input 302 in the data storage component 320 to be used as part of the historical workflows and the historical user inputs. For example, when a user accepts one of the one or more adaptive workflows, the context of the current user input may be filtered to keep only content that is material to the accepted one of the one or more adaptive workflows. In some cases, this filtering may be accomplished using an LLM that is coupled to one or more of the existing agents, such as the CEA 310, the WCA 330, the WSA 340, or the at least one worker agent 350, or with the tool library 342. After filtering, the filtered content is stored in the history library 320 to be used as accompanying context with the accepted one or more adaptive workflows. Additionally, the history library 320 may be implemented as a RAG database and both the filtered content and the accepted one or more adaptive workflows may be stored for retrieval by the CEA 310. Filtering on workflow retrieval, such as for changes in user intent during a large user input, may be accomplished using LLM capabilities without requiring additional processing.

The RA 360 may be configured to communicate with users and display workflow visualizations through the VA 370. The RA 360 may also be configured to recommend one or more next steps to one or more users based on one or more results from the one or more adaptive workflows. In some cases, the VA 370 may format the one or more results from the one or more adaptive workflows for the user(s) based on past success and requested output format(s), which may be received as part of the current user input 302, in order to produce an output 380. For example, the VA 370 may provide one or more visual representations of one or more workflows and modifications for enhanced user understanding and engagement.

Although FIG. 3 illustrates one example of an architecture 300 supporting generation of adaptive workflows using historical and current user inputs, various changes may be made to FIG. 3. For example, components can be added, omitted, combined, further subdivided, replicated, or placed in any other suitable configuration in the architecture 300 of FIG. 3 according to particular needs. Also, the architecture 300 need not include all of the agents shown, such as when the VA 370 can be omitted and other techniques may be used to alert and communicate with users.

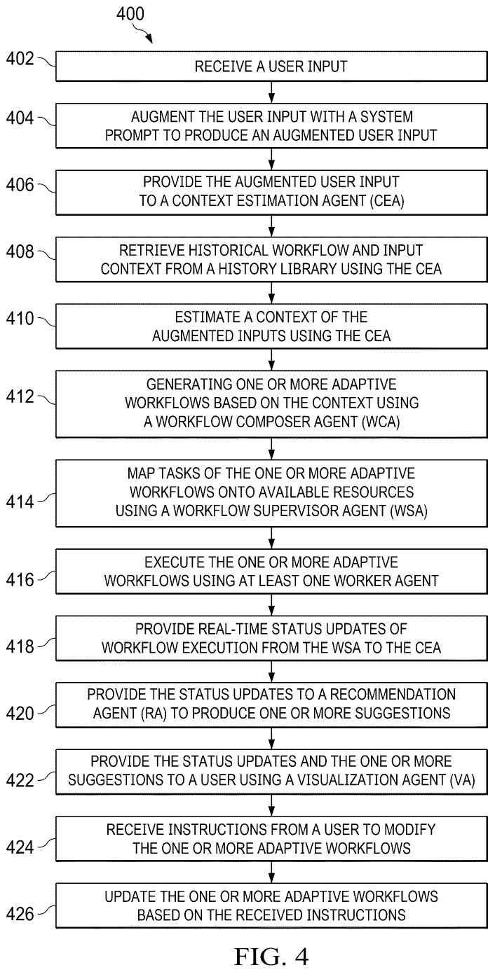

FIG. 4 illustrates an example method 400 for generating adaptive workflows using historical and current user inputs in accordance with this disclosure. In some embodiments, the method 400 may be performed using the architecture 300, which may be implemented using one or more applications 112 that are executed by the application server 106 in the system 100 of FIG. 1.

As shown in FIG. 4, a user input 302 is received at step 402, such as through the I/O unit 208 of the device 200 of FIG. 2. The user input 302 may include instructions for a required output, such as representation of particular data, and may include time constraints. The user input 302 may be standardized or tokenized in a standardization function 304 to convert the user input, such as words or text, into a vector space to be used in the architecture 300. For example, the standardization function 304 may apply word-level tokenization, character-level tokenization, or subword-level tokenization to represent words of the user input into numerical representations for processing.

The tokenized user input 302 may be augmented using a merge function 306 and additional input from a system prompt 308 in step 404. For example, in response to receiving the user input, the architecture 300 may provide template examples to aid in toolchain construction to the merge function 306 as a system prompt 308. The template examples may include suggested tool selection, uses for the suggested tools, and other toolchain information. The merge function 306 receives the tokenized user input 302 and appends the system prompt 308 to the user input 302 to produce an augmented user input. The augmented user input is provided to the CEA 310 in step 406.

Upon receiving the augmented user input 302, the CEA 310 retrieves historical workflow and historical user input from a data storage component 320 in step 408. For example, the CEA 310 may identity a possible domain of the augmented user input and request workflows from the data storage component having similar domains. Depending on the domain classification of the data storage component, the CEA 310 may request similar subdomains that potentially match the received augmented user input.

A context of the current user input 302 is estimated using the CEA 310 at step 410. The context of the current user input 302 may include a current chat history along with augmented data. To estimate the context of the current user input, the CEA may further augment the augmented user input with historical data, such as one or more historical workflows stored in the data storage component 320. For example, the CEA may analyze the historical user inputs and the historical generated workflows and estimate a context of a current user input, such as using rule-based methods, an LLM, or RAG methods. In using a rule-based method, for example, the CEA may match names of nodes within a historical workflow and verify their sequence and relationships based on the augmented user input. In using an LLM, for example, the CEA may use the augmented user input as a prompt for the LLM to identify the most relevant, such as the most similar, module in the data storage component. In using a RAG method, for example, the CEA may perform RAG on each module of the data storage component and the augmented user input and match the results using cosine matching. Supplementing the context of the user input with historical data improves efficiency of workflow generation and prevents unnecessary re-generation of similar workflows.

One or more adaptive workflows are generated using the WCA 330 at step 412. For example, the WCA 330 may include a subagent that proposes one or more workflows based on the received estimated context, including one or more historical workflows, and the augmented user input and a second agent to request a resource estimation from the contribution and resource estimation tool 332 for the proposed one or more workflows. The contribution and resource estimation tool 332 provides information on available resources, such as available memory, tools, and processing capabilities, and provides an estimate on the time and resources required for the proposed one or more workflows.

The contribution and resource estimation tool 332 may also provide feasibility feedback based on user input. For example, the contribution and resource estimation tool 332 may provide positive or negative feedback based on time constraints applied by the user input indicating whether the proposed one or more workflows will complete satisfactorily within the time constraints requested in the user input. Similarly, the feasibility feedback may relate to available tools capable of completing the proposed one or more workflows to produce a requested result in the user input. The feasibility feedback may be provided back to the CEA 310 to be forwarded to the RA and subsequently to the VA to a user for additional instructions, including modifications to address the feasibility of the requested output in the user input 302.

Once the WCA 330 proposes one or more adaptive workflows that are feasible, based on the contribution and resource estimation tool 330, the generated adaptive workflows are transferred to the WSA 340 for implementation. In particular, one or more computing tasks are mapped onto available resources using the WSA 340 at step 414. For example, the WSA 340 may pull tools identified in the one or more adaptive workflows from the tool library 342 and map one or more computing tasks to at least one worker agent 350 to implement each adaptive workflow.

The at least one worker agent 350 then executes the one or more adaptive workflows in step 416. The at least one worker agent 350 may include a plurality of subagents 352 that each implement a tool from one or more tools 354 to perform the one or more mapped computing tasks to produce an output. The at least one worker agent 350 may also include a summary agent 356 that receives the output of each of the plurality of subagents 352 and formats a single, coherent output.

One or more real-time status updates 358 of workflow execution may optionally be provided from the WSA 340, such as from the summary agent 356 upon receiving the output of one or more of the plurality of subagents 352, to the CEA 310 at step 418. For example, as the plurality of subagents 350 perform the one or more adaptive workflows, the WSA 340 may record the status of each assigned task and its corresponding subagent and provide this information to the CEA 310. For example, using the CEA 310, the one or more real-time status updates may be compared to one or more expected outputs generated by the WCA 330. If each task of the one or more adaptive workflows is completed successfully, such as without error, a status update 358 indicating successful completion is communicated to the CEA 310. However, if any error in the workflow is detected, the WSA 340 may communicate a presence of the error(s) to the CEA 310 and the RA 360 as part of step 420. This may cause the CEA 310 and the RA 360 to cancel or modify the one or more adaptive workflows, and the RA 360 may send an alert to advise the user(s) on one or more next steps via the VA 370 in step 422. Additionally or alternatively, the CEA 310 may determine if a generated workflow result is no longer needed, prompting the RA 360 to suggest one or more alternative next steps to the user(s).

Instructions may optionally be received from one or more users to modify the one or more adaptive workflows in real-time using the RA 360 by providing instructions for a workflow modification to the CEA 310 and the WCA 330 at step 424. If this occurs, the one or more adaptive workflows may optionally be updated using the CEA 310 and the WCA 330 at step 426. In some cases, this may be based on user feedback and execution outcomes. The CEA 310 receives and includes the modification instructions as part of a subsequent context estimation and provides the additional user input and updated context estimation, which may include a directly preceding workflow, to the WCA 330. The WCA 330 may use a subagent to propose a workflow modification based on the modification instructions and another subagent to assess resource estimation, such as using the context and resource estimation tool, of one or more modified adaptive workflows, such as the one or more adaptive workflows that incorporate the workflow modification. Once successfully cleared by the WCA 330 for feasibility and tool availability, the one or more modified adaptive workflows are implemented by the WSA 340 as described above.

One possible advantage of the architecture 300 and the method 400 is that, unlike approaches that generate workflows only from historical workflows, the architecture 300 and the method 400 can use historical workflows, historical user inputs, and current user input 302 to estimate contexts of the user inputs and subsequently generate workflows based on the current user input 302 and the estimated context of the current user input 302. Also, the architecture 300 and the method 400 may re-evaluate a generated workflow and compare it to an estimated context and current user input, as well as prompt user feedback for modifications. This allows for real-time adjustments and refinements during execution, ensuring workflows are both contextually accurate and efficiently executed.

Although FIG. 4 illustrates one example of a method 400 for generating adaptive workflows using historical and current user inputs, various changes may be made to FIG. 4. For example, while shown as a series of steps, various steps in FIG. 4 could overlap, occur in parallel, occur in a different order, or occur any number of times (including zero times).

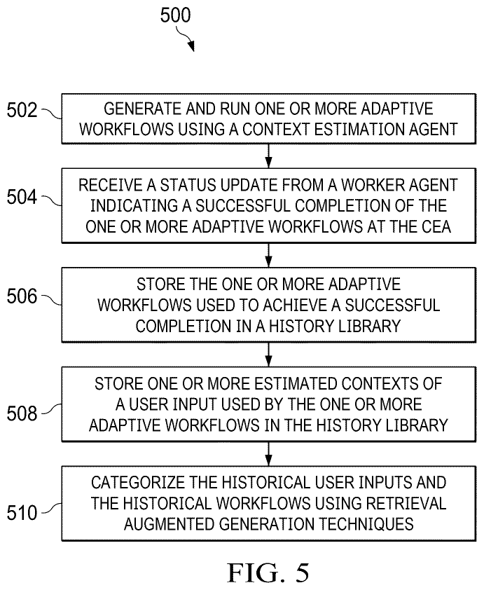

FIG. 5 illustrates an example method 500 for storing historical user inputs and historical generated workflows in a data storage component to support generation of adaptive workflows using historical and current user inputs according to this disclosure. In some embodiments, the method 500 may be performed using the architecture 300, which may be implemented using one or more applications 112 that are executed by the application server 106 in the system 100 of FIG. 1. Additionally, the method 500 may occur before, during, and/or after the method 400.

As shown in FIG. 5, one or more adaptive workflows are generated and run using the architecture 300 in step 502. For example, the method 400 of FIG. 4 may be used to generate one or more adaptive workflows based on a user input 302 as in steps 402-414 described above and subsequently running the one or more adaptive workflows as described in steps 416-420. In step 504, the CEA 310 receives a status update 358 from a worker agent 350, such as by the summary agent of the worker agent 350, indicating one or more successful completions of the one or more adaptive workflows.

In step 506, in response to receiving the status update 358 indicating successful completion(s) of the one or more adaptive workflows, the CEA 310 can store the one or more adaptive workflows into a data storage component 320. For example, if several iterations of the one or more adaptive workflows are used, such as the one or more adaptive workflows were modified to achieve the successful completion status update 358, only the final version of the one or more adaptive workflows might be stored in the data storage component 320 as part of a historical workflows database. Workflow data stored in the historical workflows database may include names and descriptions of tools and workflow modules used in the one or more adaptive workflow, order of the workflow modules in the one or more adaptive workflows, and the workflow output of the one or more adaptive workflows. Similarly, in step 508, the user input 302 used generate the one or more adaptive workflows is stored in the data storage component 320. For example, the user input 302 for all versions of the one or more adaptive workflows, such as the original prompt and any modifying prompts, may be stored as part of a historical user input database and appended to or otherwise related to the final version of the one or more adaptive workflows.

In addition to storing the one or more adaptive workflows and estimated context, the method 500 includes categorizing the historical workflows and the historical user inputs in step 510. For example, the historical user inputs and the historical workflows may be classified, such as using an LLM model, to determine a domain classification for each of the historical user inputs and their corresponding historical workflows. The desired domains for classification may be any desired domains, such as maritime, air, space, and cyber domains, depending on intended workflow generation. Once categorized, the workflow data of the historical user inputs and historical workflows may be encoded into embeddings and stored, such as in RAG collections, on a per-domain basis. In some cases, the domain workflow RAG collection can be used in a similarity search, such as by the CEA 310, to identify and reuse one or more workflows and workflow components that are part of the same domain of a new user input 302, such as in a subsequent use of the architecture 300. A RAG technique, such as cosine matching, may be used in either a multi-index system or as part of an LLM to select similarities between the domains and the new user input 302.

Although FIG. 5 illustrates one example of a method 500 for storing historical user inputs and historical generated workflows in a data storage component to support generation of adaptive workflows using historical and current user inputs, various changes may be made to FIG. 5. For example, while shown as a series of steps, various steps in FIG. 5 could overlap, occur in parallel, occur in a different order, or occur any number of times (including zero times).

It should be noted that the functions shown in or described with respect to FIGS. 1 through 5 can be implemented in a server or other electronic device(s) in any suitable manner. For example, in some embodiments, at least some of the functions shown in or described with respect to FIGS. 1 through 5 can be implemented or supported using one or more software applications or other software instructions that are executed by the processing device(s) 202 of the application server 106 or other electronic device(s). In other embodiments, at least some of the functions shown in or described with respect to FIGS. 1 through 5 can be implemented or supported using dedicated hardware components. In general, the functions shown in or described with respect to FIGS. 1 through 5 can be performed using any suitable hardware or any suitable combination of hardware and software/firmware instructions. Also, the functions shown in or described with respect to FIGS. 1 through 5 can be performed by a single electronic device or by multiple electronic devices.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A system comprising:
at least one data storage configured to store historical user inputs and historical generated workflows; and
one or more processing devices configured to execute a context estimation agent (CEA), a workflow composer agent (WCA), a workflow supervisor agent (WSA), a worker agent, and a recommendation agent (RA), wherein:
the CEA is configured to analyze the historical user inputs and the historical generated workflows using retrieval-augmented generation (RAG) to estimate a context of a current user input;
the WCA is configured to generate one or more adaptive workflows in response to the current user input based on the context estimated by the CEA such that the one or more adaptive workflows are adjusted using feedback from one or more execution results and are visualized using a visualization agent (VA);
the WSA is configured to map one or more computing tasks to the worker agent;
the worker agent is configured to provide one or more status updates of task execution to the CEA; and
the RA is configured to recommend one or more next steps to one or more users based on one or more results from the one or more adaptive workflows,
wherein the worker agent is configured to provide one or more real-time status updates of workflow execution to the CEA such that the one or more real-time status updates are compared to one or more expected outputs generated by the WCA to determine if the one or more adaptive workflows are proceeding without error.

2. The system of claim 1, wherein the at least one data storage is configured to categorize the historical user inputs and the historical generated workflows based on domain classification for efficient retrieval by the CEA.

3. The system of claim 1, wherein the CEA is configured to identify one or more patterns in the historical user inputs and the historical generated workflows to estimate the context of the current user input.

4. The system of claim 1, wherein the CEA is configured to use the RA and the VA to update the one or more adaptive workflows dynamically based on user feedback and one or more execution outcomes.

5. (canceled)

6. The system of claim 1, wherein the worker agent is configured to communicate a presence of any error to the CEA and the RA.

7. The system of claim 1, wherein the CEA is configured to receive one or more instructions from one or more users to modify the one or more adaptive workflows in real-time and provide one or more instructions for a workflow modification to the WCA for continuous adaptation.

8. A non-transitory machine-readable medium including program code that, when executed by at least one processor of an electronic device, causes the electronic device to:
store historical user inputs and historical generated workflows; and
execute a context estimation agent (CEA), a workflow composer agent (WCA), a workflow supervisor agent (WSA), a worker agent, and a recommendation agent (RA), wherein:
the CEA is configured to analyze the historical user inputs and the historical generated workflows using retrieval-augmented generation (RAG) to estimate a context of a current user input;
the WCA is configured to generate one or more adaptive workflows in response to the current user input based on the context estimated by the CEA such that the one or more adaptive workflows are adjusted using feedback from one or more execution results and are visualized using a visualization agent (VA);
the WSA is configured to map one or more computing tasks to the worker agent;
the worker agent is configured to provide one or more status updates of task execution to the CEA; and
the RA is configured to recommend one or more next steps to one or more users based on one or more results from the one or more adaptive workflows,
wherein the worker agent is configured to provide one or more real-time status updates of workflow execution to the CEA such that the one or more real-time status updates are compared to one or more expected outputs generated by the WCA to determine if the one or more adaptive workflows are proceeding without error.

9. The non-transitory machine-readable medium of claim 8, further including program code that, when executed by the at least one processor, causes the electronic device to categorize the historical user inputs and the historical generated workflows based on domain classification for efficient retrieval by the CEA.

10. The non-transitory machine-readable medium of claim 8, further including program code that, when executed by the at least one processor, causes the electronic device to identify one or more patterns in the historical user inputs and the historical generated workflows to estimate the context of the current user input.

11. The non-transitory machine-readable medium of claim 8, wherein the CEA is configured to use the RA and the VA to update the one or more adaptive workflows dynamically based on user feedback and one or more execution outcomes.

12. canceled

13. The non-transitory machine-readable medium of claim 8, wherein the worker agent is configured to communicate a presence of any error to the CEA and the RA.

14. The non-transitory machine-readable medium of claim 8, wherein the CEA is configured to receive one or more instructions from one or more users to modify the one or more adaptive workflows in real-time and provide one or more instructions for a workflow modification to the WCA for continuous adaptation.

15. A method comprising:
storing historical user inputs and historical generated workflows; and
executing a context estimation agent (CEA), a workflow composer agent (WCA), a workflow supervisor agent (WSA), a worker agent, and a recommendation agent (RA), wherein:
the CEA analyzes the historical user inputs and the historical generated workflows using retrieval-augmented generation (RAG) to estimate a context of a current user input;
the WCA generates one or more adaptive workflows in response to the current user input based on the context estimated by the CEA such that the one or more adaptive workflows are adjusted using feedback from one or more execution results and are visualized using a visualization agent (VA);
the WSA maps one or more computing tasks to the worker agent;
the worker agent provides one or more status updates of task execution to the CEA; and
the RA recommends one or more next steps to one or more users based on one or more results from the one or more adaptive workflows,
wherein the worker agent provides one or more real-time status updates of workflow execution to the CEA such that the one or more real-time status updates are compared to one or more expected outputs generated by the WCA to determine if the one or more adaptive workflows are proceeding without error.

16. The method of claim 15, further comprising:
categorizing the historical user inputs and the historical generated workflows based on domain classification for efficient retrieval by the CEA.

17. The method of claim 15, wherein the CEA identifies one or more patterns in the historical user inputs and the historical generated workflows to estimate the context of the current user input.

18. The method of claim 15, wherein the CEA uses the RA and the VA to update the one or more adaptive workflows dynamically based on user feedback and one or more execution outcomes.

19. (canceled)

20. The method of claim 15, wherein the CEA receives one or more instructions from one or more users to modify the one or more adaptive workflows in real-time and provides one or more instructions for a workflow modification to the WCA for continuous adaptation.

21. The system of claim 1, wherein, to estimate the context of the user input, the CEA is further configured to perform cosine matching.

22. The system of claim 1, wherein a large language model (LLM) is coupled to one or more of the CEA, the WCA, the WSA, or the worker agent, and
the one or more processing devices is further configured to filter, using the LLM, the context of the current user input by keeping only content that is material to one of the one or more adaptive workflows accepted by the one or more users.

23. The system of claim 22, wherein the one or more processing devices is further configured to store the filtered context of the current user input in the at least one data storage as a RAG database.
